(19) United States
(12) Patent Application Publication
(10) Pub. No.: US 2026/0093425 A1
(43) Pub. Date: Apr. 2, 2026

(54) IMAGE FORMING APPARATUS AND CONTROL METHOD FOR IMAGE FORMING APPARATUS

(71) Applicant: SHARP KABUSHIKI KAISHA, Osaka (JP)

(72) Inventor: SHO KAMIHISA, Osaka (JP)

(21) Appl. No.: 19/335,254

(22) Filed: Sep. 22, 2025

(30) Foreign Application Priority Data
Sep. 27, 2024 (JP) 2024-168649

(51) Int. Cl. G06F 3/12

(52) U.S. Cl. CPC G06F 3/121; G06F 3/1234

(57) ABSTRACT

An image forming apparatus includes a controller that controls execution of a job, and a display that displays a message regarding movement of a housing under control of the controller, in which the controller controls a display mode of the message regarding the movement of the housing, based on a predetermined condition when an event occurs and a countermeasure involving the movement of the housing is performed as a countermeasure for the event that has occurred.

### TECHNICAL FIELD

The present disclosure relates to an image forming apparatus and the like.

### BACKGROUND ART

For example, it is known that, when a jam occurs in a sheet transport path provided on the rear side of an apparatus, the entire apparatus may need to be moved in order to clear the jam.

It is also known that an installation situation of an image forming apparatus is determined when a jam occurs, an indication that the apparatus needs to be moved is displayed on a jam release screen when the apparatus needs to be moved, and a “Please press when movement is completed” button is displayed when the next action is required after the apparatus is moved.

### PRIOR ART DOCUMENTS

### Patent Documents

[Patent Document 1] JP 2005-306517

[Patent Document 2] JP 2014-224943

### SUMMARY

### Technical Problem

An object of the disclosure is to provide an image forming apparatus and the like which are capable of flexibly performing display control of a message regarding the movement of a housing when the movement of the housing is involved in order to cope with an event that has occurred.

### Solution to Problem

In order to solve the above problem, an image forming apparatus according to the disclosure includes one or more controllers that control execution of a job, and a display that displays a message regarding movement of a housing under control of the one or more controllers, in which the one or more controllers control a display mode of the message regarding the movement of the housing, based on a predetermined condition when an event occurs and a countermeasure involving the movement of the housing is performed as a countermeasure for the event that has occurred.

In addition, a control method for an image forming apparatus according to the disclosure includes controlling execution of a job, displaying a message regarding movement of a housing under control of one or more controllers, and controlling a display mode of the message regarding the movement of the housing, based on a predetermined condition when an event occurs and a countermeasure involving the movement of the housing is performed as a countermeasure for the event that has occurred.

### Advantageous Effects of Disclosure

According to the disclosure, it is possible to provide an image forming apparatus and the like which are capable of flexibly performing display control of a message regarding movement of a housing when the movement of the housing is involved in order to cope with an event that has occurred.

### BRIEF DESCRIPTION OF DRAWINGS

FIG. 1 is a diagram illustrating an overall configuration of an image forming apparatus according to a first embodiment.

FIG. 2 is a diagram illustrating a functional configuration of the image forming apparatus according to the first embodiment.

FIG. 3 is a flowchart illustrating a flow of a process according to the first embodiment.

FIGS. 4A-4D are diagrams illustrating an example of an operation according to the first embodiment.

FIG. 5 is a diagram illustrating an example of an operation according to the first embodiment.

FIG. 6 is a flowchart illustrating a flow of a process according to a second embodiment.

FIG. 7 is a diagram illustrating an example of an operation according to the second embodiment.

FIG. 8 is a diagram illustrating an example of an operation according to the second embodiment.

FIG. 9 is a diagram illustrating an example of an operation according to the second embodiment.

FIG. 10 is a flowchart illustrating a flow of a process according to a third embodiment.

FIGS. 11A-11E are diagrams illustrating an example of an operation according to the third embodiment.

FIG. 12 is a diagram illustrating an example of an operation according to the third embodiment.

FIGS. 13A-13B are diagrams illustrating an example of an operation according to the third embodiment.

FIGS. 14A-14C are diagrams illustrating an example of an operation according to the third embodiment.

FIGS. 15A-15C are diagrams illustrating an example of an operation according to a fourth embodiment.

### DESCRIPTION OF EMBODIMENTS

Hereinafter, embodiments of the disclosure will be described with reference to the drawings. In the disclosure, a multifunction apparatus capable of realizing jobs related to copying, faxing, e-mail, and the like in a single housing will be described as one form of an image forming apparatus. In the disclosure, an image forming apparatus is not limited to a multifunction apparatus as long as a configuration is capable of forming an input image based on a print job on paper, and may be a printer, a copier, a fax machine, or the like. Incidentally, the following embodiment is an example for describing the disclosure, and the technical content of the description in the claims is not limited to the following description.

Some image forming apparatuses involve an opening/closing operation of a cover member provided on a housing of the image forming apparatus in order to cope with an event that has occurred. Depending on the apparatus configuration, the cover member may be provided on the rear side or the side surface side of the housing, and in order to operate the cover member, the user may move the housing (apparatus) itself (for example, lift and invert the housing to change the front and back of the housing).

Examples of such an event that may involve movement of the housing include a paper jam, replacement of a maintenance item such as a toner or a developing unit, release of fixing pressure during printing on cardboard or the like, and cleaning of a high-density correction sensor, and the user can take an appropriate action in accordance with the event that has occurred, thereby clearing the event that has occurred.

Here, the countermeasure according to the disclosure refers to work, action, confirmation, or the like performed by the user in order to remove a factor causing the event that has occurred, such as work of removing a sheet that has caused a paper jam when the event that has occurred is a jam, work of replacing a maintenance item when the event that has occurred is a notification of near-end of the maintenance item, work of releasing fixing pressure in a fixing device when the event that has occurred is specific to printing of an image on cardboard or the like, or work of cleaning a high-density correction sensor when the event that has occurred is a high-density correction error. In the disclosure, a situation in which the cause of the event that has occurred is removed by the countermeasure is referred to as the clearing of the event, and the resolution of the event may be determined subjectively by the user or may be determined mechanically by a multifunction apparatus (for example, based on whether a sheet related to a paper jam is detected, or based on reception of a countermeasure completion instruction to be described later).

When the event is cleared by an appropriate action and the housing has been moved to clear the event, the moved housing needs to be returned to its original position (state). In the disclosure, a message displayed with the intention of returning the moved housing to the original position (state) is referred to as a message regarding the movement of the housing.

Incidentally, in the related art as illustrated, there are problems that, (1) in a production process of an image forming apparatus or work such as maintenance/operation check by a service person, when a message regarding movement of the housing (for example, “Please press when movement is completed”) is displayed, work related to production or maintenance is hindered, (2) depending on an occurrence timing of an event (jam), there is a situation in which a job is continuously performed after the event is cleared, but an operation of canceling the continued job cannot be performed only by the display of a message regarding movement of the housing (for example, “Please press when movement is completed”), and the job is automatically restarted, and paper is wasted, (3) when a jam or the like and another problem occur in a document feeding device at the same time and a message regarding movement of the housing is displayed first, display of work guidance related to the document feeding device is hindered, and the job cannot be correctly restarted, and (4) when the user views an operation panel after moving the housing, the user is in a position to look into from above, and it is difficult to read a jam guidance, a message, or the like.

In the disclosure, in order to solve the above problem, an image forming apparatus and the like which are capable of flexibly performing display control of a message regarding movement of a housing when the movement of the housing is involved in order to cope with an event that has occurred are realized in the following embodiments.

### 1 First Embodiment

A first embodiment is a form in which, after completion of a countermeasure for an event that has occurred, a display mode of a message regarding movement of a housing is determined on the basis of a predetermined condition, and particularly, a form in which, when it is determined that a countermeasure for an event that has occurred corresponds to a specific operation by a user as a predetermined condition, restriction of display of a message regarding movement of a housing is determined as a display mode of a message regarding the movement of the housing.

### 1.1 Functional Configuration

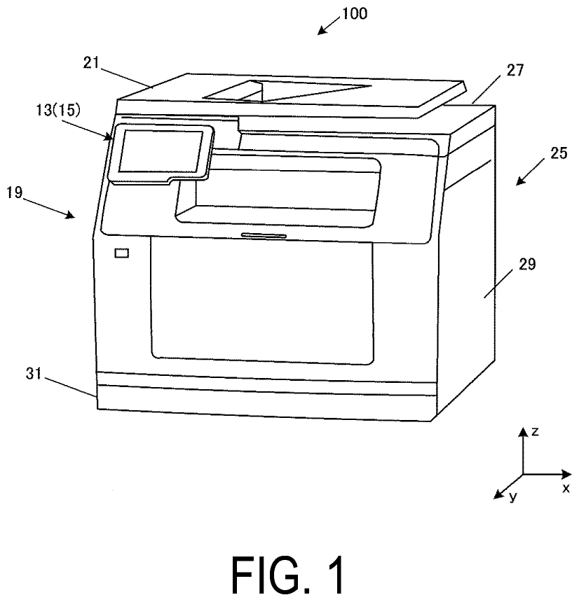

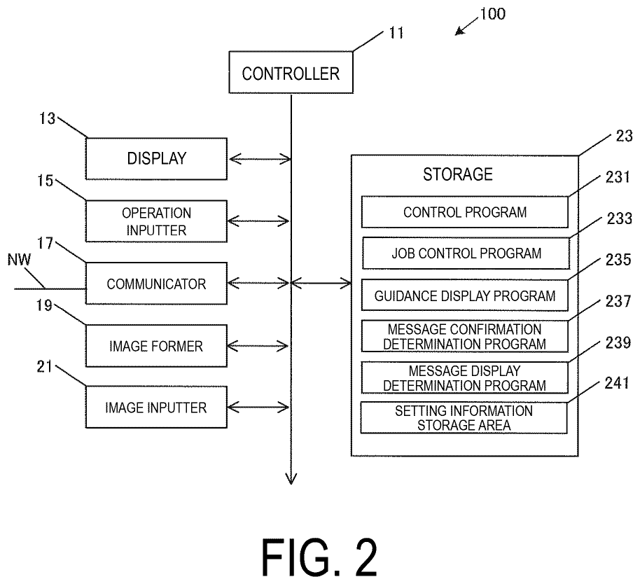

FIG. 1 is an external perspective view illustrating an overall configuration of a multifunction apparatus 100 according to a first embodiment. FIG. 2 is a functional configuration diagram of the multifunction apparatus 100. The multifunction apparatus 100 includes a housing 25 that forms the exterior of the apparatus. The housing 25 is a box-shaped member with a bottom that accommodates at least an image former 19 to be described below and a paper feed (transport) mechanism (not shown) for feeding paper from an attached feed tray 31 to the image former 19. The housing 25 is provided with a cover 27 as a cover member configured to be openable and closable with respect to the rear side (−y-axis direction in the figure), and a cover 29 as a cover member configured to be openable and closable with respect to the right side (x-axis direction in the figure). The cover 29 may be provided on the left side (−x-axis direction in the figure) or may be provided on both the left and right sides.

Further, the feed tray 31, which is a box-shaped member with an open top for accommodating paper, is provided in a lower portion of the front side of the housing 25 to be freely attached and detached with respect to the front side (a y-axis direction in the figure) of the housing 25. The cover 27 and the cover 29 are regulating members that restrict the user from accessing the inside of the housing 25 when an operation state is a “closed” state, and allow access to the inside of the housing 25 when the operation state is an “open” state. Further, similarly to the cover 27 and the cover 29, the feed tray 31 is a regulating member that restricts the user from accessing the inside of the housing 25 when the operation state is a “mounted (stored)” state, and allows the user to access the inside of the housing 25 when the operation state is a “removed” state.

The multifunction apparatus 100 including such a housing 25 includes a controller 11, a display 13, an operation inputter 15, a communicator 17, the image former 19, an image inputter 21, and a storage 23.

The controller 11 comprehensively controls the entire multifunction apparatus 100. The controller 11 can be configured with one or a plurality of processing apparatuses (for example, a central processing unit (CPU) or a system on chip (SoC)). The controller 11 realizes functions by reading and executing various programs stored in the storage 23. The controller 11 may be configured of one or more control circuits.

The display 13 displays various types of information to the user. The display 13 can be configured of, for example, a liquid crystal display (LCD) or an organic electro-luminescence (EL) display. The display 13 displays an operation screen in accordance with a state of the multifunction apparatus 100 (for example, a home screen (not shown), an execution screen (operation screen) related to a setting or execution of each job, or jam guidance).

The operation inputter 15 receives information input from the user, or the like. The operation inputter 15 can be configured of, for example, various input devices such as operation keys such as hard keys and software keys, and buttons. The operation inputter 15 can also be configured as a touch panel that allows information to be input via the display 13. When the operation inputter 15 is configured as a touch panel, the operation inputter 15 can detect a user's touch, tap, or swipe operation or the like with respect to an object such as an operation key and an operation button displayed via the display 13, and acquire coordinate information, pressure sensitive information, or the like on the touch panel. As an input scheme for a touch panel, for example, a general scheme such as a resistive film scheme, an infrared scheme, an electromagnetic induction scheme, or a capacitive scheme can be employed.

The communicator 17 includes a wired, wireless, or wired and wireless interface for performing communication with another device via a network NW such as a local area network (LAN), a wide area network (WAN), the Internet, a telephone line, or a fax line. Further, the communicator 17 may include an interface related to (short-range) wireless communication technology, such as Bluetooth (registered trademark), near field communication (NFC), Wi-Fi (registered trademark), ZigBee (registered trademark), infrared data association (IrDA), or wireless USB.

The image former 19 accepts paper from the feed tray 31, forms an output image (printed image) based on image data on the paper, and then discharges the paper to a paper discharge tray. The image former 19 can be configured, for example, of a laser printer that employs an electrophotographic scheme. In this case, the image former 19 performs image formation using toner supplied from a toner cartridge (not shown) corresponding to toner colors (for example, cyan, magenta, yellow, and black).

The image inputter 21 can be configured as a scanner apparatus including an automatic document feeding device (SPF: single pass feeder) as a document feeding device, a flatbed for placing and reading a document, and the like, in addition to an image sensor such as a charge coupled device (CCD) or a contact image sensor (CIS). A configuration of the image inputter 21 is not particularly limited as long as the image inputter 21 is capable of generating image data by reading a reflected light image from a document image with an image sensor. The image inputter 21 can also be configured as an interface capable of acquiring image data stored in a storage device such as a USB memory and having a file format such as TIFF, BMP, JPEG, or the like, or image data transmitted from an external terminal device (not shown). The image inputter 21 may be configured to generate image data for data transmission by performing, for example, shading correction or density correction on the acquired image data.

The storage 23 is one or more storage devices that store various programs and various pieces of data necessary for an operation of the multifunction apparatus 100. The storage 23 can be configured of, for example, a storage device such as a random access memory (RAM), a solid state drive (SSD), a hard disk drive (HDD), or a read only memory (ROM).

In the first embodiment, the storage 23 stores a control program 231, a job control program 233, a guidance display program 235, a message confirmation determination program 237, and a message display determination program 239, and secures a setting information storage area 241.

The control program 231 is a program that is read by the controller 11 when the multifunction apparatus 100 is controlled in an integrated manner. The controller 11 that has read the control program 231 controls driving of hardware such as the display 13, the operation inputter 15, the communicator 17, the image former 19, and the image inputter 21.

The job control program 233 is a program that is read by the controller 11 when executing various jobs, such as a printing-related job including a copy job and a print job, a scan job, a fax job, and an image transmission job. The controller 11 that has read the job control program 233 sets an apparatus mode of the multifunction apparatus 100 to a job mode (copy mode, print mode, scan mode, fax mode, image transmission mode, or the like) for executing each job, and executes a job for which an execution instruction has been received. The controller 11 that has read the job control program 233 interrupts the print job that is being executed, for example, when an event such as a jam occurs during the execution of the print job. Further, when the movement of the housing 25 is involved to clear the jam that has occurred, the controller 11 restricts the resumption (execution) of the interrupted job until the user confirms a message regarding the movement of the housing 25 after the event has been cleared based on the guidance.

The guidance display program 235 is a program that the controller 11 reads when displaying guidance for resolving an event such as a jam that has occurred. For example, when the event that has occurred is a jam, the controller 11 that reads the guidance display program 235 specifies the location at which the jam has occurred. The controller 11 displays a guidance including a method of operating a regulating member to access a specific location at which the jam has occurred. For example, when a jam has occurred in a location that can be accessed through the cover 27 on the rear side of the multifunction apparatus 100, the controller 11 displays guidance including an operation of opening and closing the cover 27.

The message confirmation determination program 237 is a program that is read by the controller 11 when the housing 25 of the multifunction apparatus 100 needs to be moved to clear an event such as a jam that has occurred, and when it is determined whether the user has confirmed the message regarding the movement of the housing 25 that is displayed after the event is cleared. When the controller 11 that has read the message confirmation determination program 237 determines that a confirmation instruction indicating that the message has been confirmed by the user has been received, the controller 11 determines to resume (execute) the print job interrupted due to the occurrence of the event.

The message display determination program 239 is a program that is read by the controller 11 when it is determined whether to display the message regarding the movement of the housing 25. When the controller 11 that has read the message display determination program 239 determines that a countermeasure for the event that has occurred corresponds to specific work by the user, the controller 11 restricts the display of the message regarding the movement of the housing 25. Here, the specific work is work different from work performed when a countermeasure for an event that has occurred during normal use by a general user, such as adjustment work during production of the multifunction apparatus 100 or maintenance work by a maintenance user (service person). When the controller 11 determines that the countermeasure for the event that has occurred corresponds to the specific work, the controller 11 restricts the display of the message regarding the movement of the housing 25. Note that the controller 11 is only required to determine whether the countermeasure corresponds to the specific work, for example, based on whether an operation mode of the multifunction apparatus 100 is a maintenance user mode (service mode) in which only a maintenance user (service person) can perform an operation. In addition, it is possible to take countermeasure by disabling the function performed by the message display determination program 239 as specific work to restrict the display of message regarding the movement of the housing 25 during the adjustment work at the time of production, and by enabling the function of the message display determination program 239, which had been disabled, during final adjustment (during initialization) at the time of shipment.

The setting information storage area 241 is a storage area that stores apparatus setting information of the multifunction apparatus 100, setting information required to execute a job, guidance-related information required to display guidance in response to an event that has occurred, messages regarding the movement of the housing 25, and the like.

### 1.2 Flow of Process

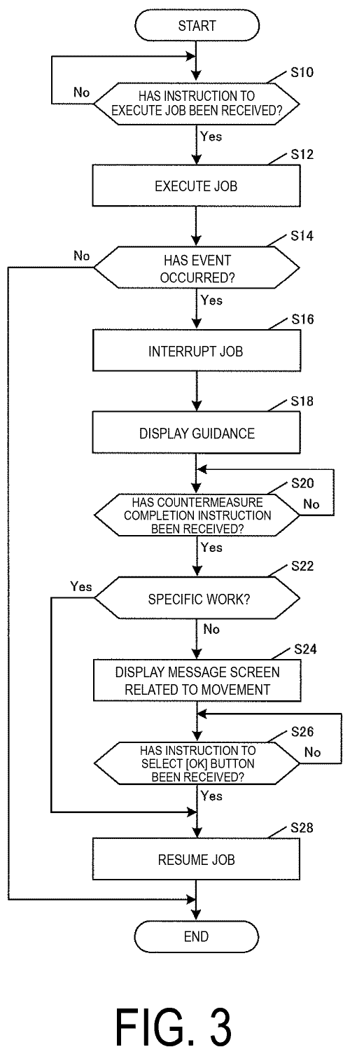

Next, a flow of a process according to the first embodiment will be described with reference to a flowchart in FIG. 3. The process described in FIG. 3 is a process that is executed by the controller 11 of the multifunction apparatus 100 reading the control program 231, the job control program 233, the guidance display program 235, the message confirmation determination program 237, the message display determination program 239, and the like. In the following description, it is assumed that an event to be cleared in FIG. 3 is an event involving the movement of the housing 25.

When the process starts, the controller 11 determines whether an instruction to execute a job has been received via a job execution screen (not shown) or the like (step S10).

When the controller 11 determines that the instruction to execute a job has been received, the controller 11 executes the job (step S10; Yes→step S12). When the controller 11 determines that the instruction to execute a job has not been received, the controller 11 waits until the instruction to execute the job is received (step S10; No).

When the job is executed, the controller 11 determines whether an event such as a jam has occurred (step S14). Here, when it is determined that an event has occurred, the controller 11 interrupts the job being executed (step S14; Yes→step S16). On the other hand, when it is determined that an event has not occurred, the controller 11 ends the process (step S14; No→End).

After interrupting the job, the controller 11 displays guidance for the user to cope with an event (step S18).

The user moves the housing 25 in accordance with the displayed guidance and copes with the event that has occurred, thereby clearing the event. Then, the controller 11 determines whether a countermeasure completion instruction has been received (step S20). Examples of the countermeasure completion instruction include reception of an instruction to select an end button for receiving an instruction to end the guidance by the user, a detection result of an operation state of a regulating member such as the covers 27 and 29, a confirmation result of the resolution of the event, and the like.

When it is determined that the countermeasure completion instruction has been received, the controller 11 determines whether an operation related to the countermeasure corresponds to a specific operation (work) (step S20; Yes→step S22). When the controller 11 determines that an operation related to the countermeasure corresponds to a specific operation, the controller 11 omits processes related to step S24 and step S26, resumes the job interrupted in step S16, and ends the process (step S22; Yes→step S28). On the other hand, when it is determined that an operation related to the countermeasure does not correspond to a specific operation, the controller 11 displays a message screen related to the movement of the housing 25 (step S22; No→step S24).

Then, the controller 11 determines whether an OK button selection instruction, which indicates that the user has confirmed the message regarding the movement of the housing 25, has been received on the displayed message (step S26).

When the controller 11 determines that the OK button selection instruction has been received, the controller 11 resumes the job interrupted in step S16 and ends the process (step S26; Yes→step S28→end). Note that, when it is determined that the OK button selection instruction has not been received, the controller 11 waits until the controller 11 receives the selection instruction (step S26; No).

### 1.3 Example of Operation

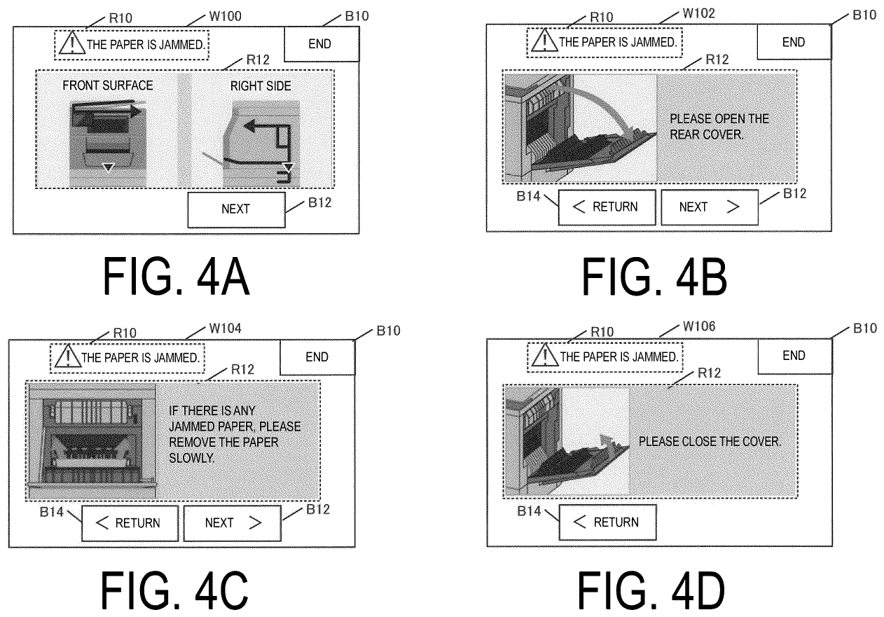

Next, an example of an operation according to the first embodiment will be described. FIGS. 4A to 4D are diagrams illustrating examples of configurations of guidance screens W100 to W106 displayed by the controller 11 when a jam, which is an example of an event, occurs. The guidance screens W100 to W106 illustrated in FIGS. 4A to 4D are examples of jam guidance provided to the user to clear the jam that has occurred, and are configured so that the jam can be cleared by being operated in accordance with a procedure shown in order of FIGS. 4A, 4B, 4C, and 4D. FIGS. 4A to 4D relate to guidance for clearing a jam through the cover 27 provided on the rear side of the multifunction apparatus 100. In FIGS. 4A to 4D, common components are denoted by the same reference numerals for description.

FIG. 4A illustrates an example of a configuration of the guidance screen W100 that the controller 11 displays after a jam occurs, and is a screen called a jam map. The guidance screen W100 includes an event display area R10 for displaying the content of an event that has occurred, a guidance display area R12 for displaying the content of a guidance, an End button B10, and a Next button B12. A schematic diagram illustrating a location at which the jam has occurred may be changed depending on the number of locations at which the jam has occurred (for example, when the number of locations at which the jam has occurred is 1, this may be a single diagram showing either the front or right side).

The event display area R10 illustrated in FIG. 4A is an example in which “The paper is jammed,” indicating that the event that has occurred is a jam is displayed. The guidance display area R12 schematically shows a location at which the jam has occurred. The user can visually check the location at which the jam has occurred by checking a schematic diagram displayed in the guidance display area R12.

The End button B10 is a button for receiving an instruction to end the guidance from the user. When the controller 11 receives a selection instruction as a countermeasure completion instruction of the End button B10 from the user, the controller 11 executes processes related to step S22 and the subsequent steps in FIG. 3.

The Next button B12 is a button for receiving a screen transition instruction from the user. When the controller 11 receives an instruction to select the Next button B12 from the user, the controller 11 causes the screen to transition to the guidance screen W102 illustrated in FIG. 4B.

FIG. 4B illustrates an example of the configuration of the guidance screen W102 that the controller 11 displays when receiving an instruction to select the Next button B12 on the guidance screen W100. A display configuration of the guidance screen W102 is obtained by adding a Back button B14 to the guidance screen W100 illustrated in FIG. 4A.

In the guidance display area R12 of the guidance screen W102, a method of operating the cover 27 for accessing the inside of the multifunction apparatus 100 is displayed. FIG. 4B illustrates an example, as a method of operating the cover 27, in which a message having a content of “Please open the rear cover”, and an illustration including the cover 27 and an arrow indicating a direction in which the cover 27 is opened are displayed in the guidance display area R12.

The Back button B14 is a button for receiving the screen transition instruction from the user. When the controller 11 receives an instruction to select the Back button B14 from the user, the controller 11 causes the screen to transition to the guidance screen W100 illustrated in FIG. 4A.

FIG. 4C illustrates an example of the configuration of the guidance screen W104 displayed by the controller 11 when receiving an instruction to select the Next button B12 on the guidance screen W102. A display configuration of the guidance screen W104 is the same as that of the guidance screen W102 illustrated in FIG. 4B.

In the guidance display area R12 of the guidance screen W104, a method of accessing the inside of the multifunction apparatus 100 and removing the jammed paper is displayed following the method of operating the cover 27 displayed in the guidance display area R12 of the guidance screen W102. FIG. 4C illustrates an example, as a method of removing the paper, in which a message having a content of “If there is any jammed paper, please remove the paper slowly” and an illustration including the paper and an arrow indicating a paper removal direction are displayed in the guidance display area R12.

FIG. 4D illustrates an example of the configuration of the guidance screen W106 displayed by the controller 11 when receiving an instruction to select the Next button B12 on the guidance screen W104. Because the guidance screen W106 is a final screen of guidance related to clearing a jam, the Next button B12 illustrated in the guidance screens W100 to W104 is not provided.

In the guidance display area R12 of the guidance screen W106, a method of operating the cover 27 after removing the jammed paper is displayed. FIG. 4D illustrates an example, as a method of operating the cover 27, in which a message having a content of “Please close the cover” and an illustration including the cover 27 and an arrow indicating a direction in which the cover 27 is closed are displayed in the guidance display area R12.

In the first embodiment, when the user confirms the message content of “Please close the cover” displayed in the guidance display area R12 and inputs an instruction to select the End button B10 on the guidance screen W106 as a countermeasure completion instruction, it is determined whether an operation related to clearing of a jam as an event corresponds to a specific operation. When the controller 11 determines that the operation related to clearing of a jam does not correspond to a specific operation, the controller 11 displays a message regarding the movement of the housing 25 illustrated in the next drawing. On the other hand, when the controller 11 determines that the operation related to clearing of a jam corresponds to a specific operation, the controller 11 restricts the display of the message regarding the movement of the housing 25.

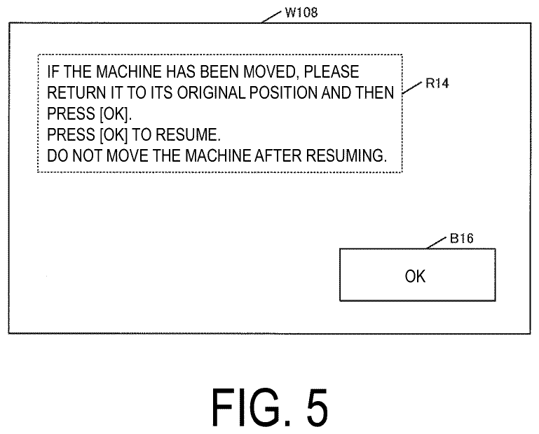

FIG. 5 illustrates an example of the configuration of a message screen W108 that displays the message regarding the movement of the housing 25 displayed by the controller 11 when receiving an instruction to select the End button B10 on the guidance screen W106 in FIG. 4D. The user can select the End button B10 on the guidance screens W100 to W104 in FIGS. 4A to 4C, and when the End button B10 is selected on any of the guidance screens W100 to W104 and the paper jam has been cleared at that point in time, the controller 11 ends the jam guidance and displays the message screen W108.

The message screen W108 includes a message display area R14 that displays, as an example of a message regarding the movement of the housing 25, “If the machine has been moved, please return it to its original position and then press [OK]. Press [OK] to resume. Do not move the machine after resuming,” and an OK button B16 for receiving a selection instruction when the message displayed in the message display area R14 is confirmed by the user. Note that a cancel button for canceling a job may be provided in the message screen W108.

When the controller 11 receives an instruction to select the OK button B16 from the user, it resumes the job (print job) interrupted in step S16 of FIG. 3. The OK button B16 also functions as a button for ending the display of the message screen W108.

On the other hand, when the countermeasure for the event that has occurred corresponds to a specific operation such as a production process of the multifunction apparatus 100 or work such as maintenance/operation check by a service person, the display of the message screen W108 is restricted.

As described above, according to the first embodiment, when the countermeasure for the event that has occurred corresponds to a specific operation (work) such as a production process of an image forming apparatus or work such as maintenance/operation check by a service person, it is possible to prevent work related to production or maintenance from being hindered by restricting the display of a message regarding the movement of the housing 25. On the other hand, when the countermeasure for the event that has occurred does not correspond to the above-mentioned specific operation (work), the controller 11 can display a message regarding the movement of the multifunction apparatus 100 in the message display area R14 to alert the user that, when the housing 25 is moved, an operation of returning it to its original position is required.

### 2 Second Embodiment

In a second embodiment, when there is a job to be executed after completion of a countermeasure for an event as a predetermined condition, a selection button for receiving an instruction to stop the execution of the job is displayed on a display together with a message regarding the movement of a housing as a display mode for the message regarding the movement of the housing.

Since a functional configuration of the multifunction apparatus 100 according to the second embodiment can be the same as that of the first embodiment, description thereof will be omitted here. Note that a controller 11 that has read a job control program 233 can determine whether there is a job to be executed after the completion of a countermeasure for an event.

### 2.1 Flow of Process

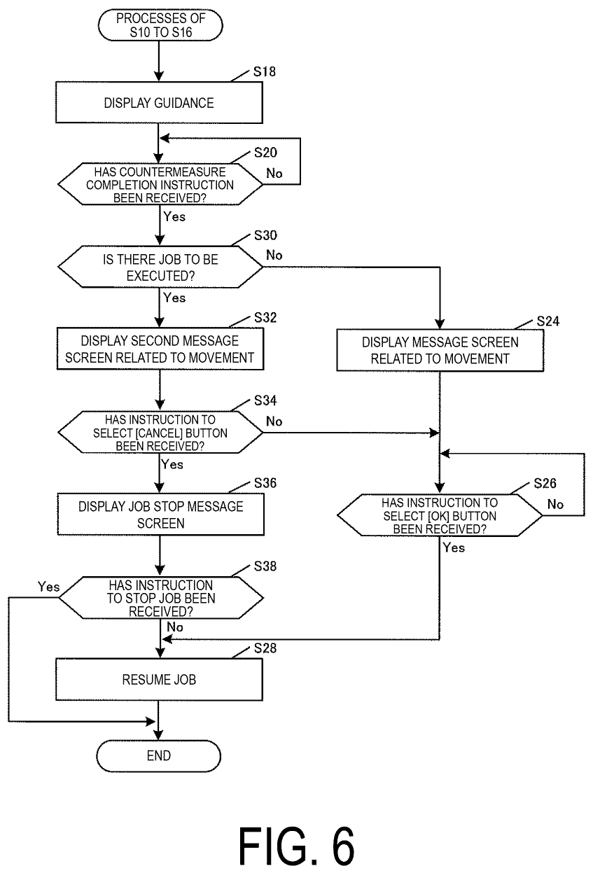

A flow of a process according to the second embodiment can be described by replacing the flowchart of FIG. 3 according to the first embodiment with a flowchart of FIG. 6. Thus, in FIG. 6, the same processes as those in FIG. 3 are denoted by the same step numbers, and the description thereof will be omitted. For convenience of description, in FIG. 6, the description of the processes of steps S10 to S16 in FIG. 3 will be omitted.

In step S18, the controller 11 displays guidance for the user to cope with an event (step S18).

In step S20, when it is determined that a countermeasure completion instruction is received, the controller 11 determines whether there is a job to be executed after a countermeasure for the event is completed (step S20; Yes→step S30). When it is determined that there is a job to be executed, the controller 11 displays a second message screen related to the movement of the housing 25 (step S30; Yes→step S32). The second message screen may have a screen configuration in which a selection button (cancel button) for receiving a screen transition instruction to transition to a screen (job stop message screen) for receiving a job execution stop instruction is provided in the configuration of the message screen (message screen W108) related to the movement of the housing 25 described in the first embodiment. On the other hand, when it is determined that there is no job to be executed, the controller 11 executes the processes of steps S24 and S26 described in FIG. 3 (step S30; No→step S24→step S26). Note that the description of the processes related to steps S24 and S26 will be omitted here.

Next, the controller 11 determines whether the cancel button, which is a selection button for receiving a screen transition instruction to transition to the job stop message screen, is selected by the user on the second message screen (step S34). When it is determined that the cancel button is selected by the user, the controller 11 displays the job stop message screen (step S34; Yes→step S36). When it is determined that the cancel button has not been selected by the user, the controller 11 proceeds to step S26 (step S34; No→step S26).

The controller 11 determines whether a job stop instruction has been received from the user via the displayed job stop message screen (step S38). When it is determined that the job stop instruction has been received from the user, the controller 11 stops executing the job to be executed and ends the process (step S38; Yes→End). On the other hand, when it is determined that the job stop instruction has not been received from the user, the controller 11 resumes the job to be executed and ends processing (step S38; No→step S28→End).

### 2.2 Example of Operation

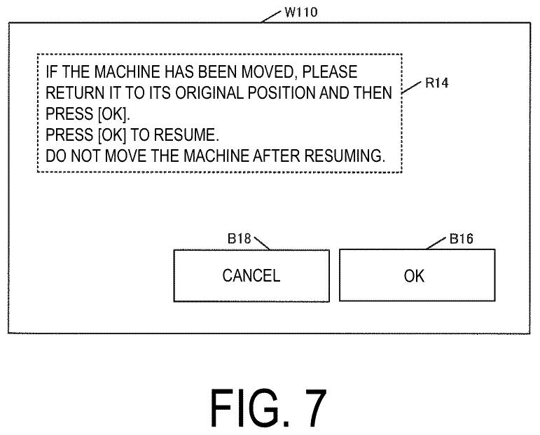

FIG. 7 is a configuration example of a message screen W110 which is a second message screen that displays a message regarding the movement of the housing 25. The message screen W110 includes a cancel button B18 in addition to the configuration of the message screen W108 illustrated in FIG. 5.

The cancel button B18 is a selection button for receiving an instruction to display a job stop message screen for inquiring the user whether or not to stop an interrupted job. When the controller 11 receives an instruction to select the cancel button B18, the controller 11 displays a job stop message screen W112, which will be described with reference to the next drawing.

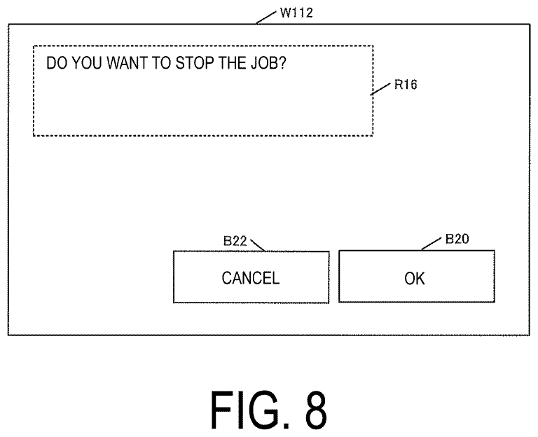

FIG. 8 is a diagram illustrating an example of the configuration of the job stop message screen W112. The job stop message screen W112 includes a message display area R16 that displays “Do you want to stop the job?” as an example of a message for inquiring the user whether or not to stop an interrupted job, an OK button B20 for receiving an instruction to stop the job from the user, and a Cancel button B22 for receiving an instruction to cancel the instruction to stop the job. When the controller 11 receives an instruction to select the OK button B20 from the user, the controller 11 stops the interrupted job and ends the process. At this time, the controller 11 may display a message screen indicating that the job has been stopped. On the other hand, when the controller 11 receives an instruction to select the Cancel button B22 from the user, the controller 11 receives an instruction to cancel the instruction to stop the job, and causes the screen to transition to the message screen W110 illustrated in FIG. 7.

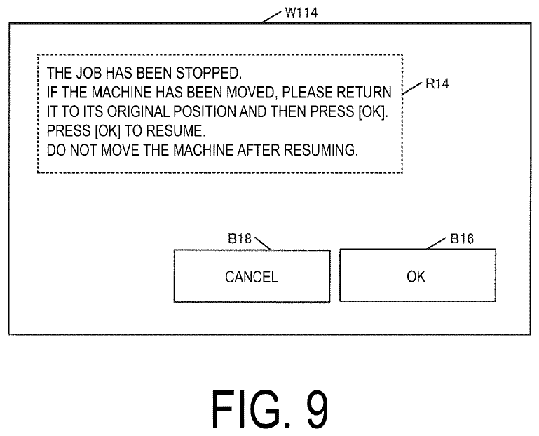

FIG. 9 is a configuration example of a message screen W114 displayed by the controller 11 when the stopping of a job is selected via the job stop message screen W112. The message screen W114 may have the same configuration as the message screen W110 illustrated in FIG. 7. The message screen W114, upon receiving an instruction to select the OK button B20 from the user, can display, in the message display area R14, a message indicating that the interrupted job has been stopped (for example, “The job has been stopped. If the machine has been moved, . . . ”).

As described above, according to the second embodiment, for example, when an event such as a jam occurs and there is a job to be continued after a countermeasure for the event is completed, the job can be canceled, and thus, for example, it is possible to prevent paper or the like from being wastefully consumed due to automatic resumption of the job.

### 3 Third Embodiment

In a third embodiment, description will be given of a mode in which, when an event that has occurred involves a jam that has occurred in a document feeding device as a predetermined condition, a message regarding document removal is displayed before a message regarding movement of a housing is displayed.

Since a functional configuration of a multifunction apparatus 100 according to the third embodiment can be the same as that in the first embodiment, the description thereof will be omitted here.

### 3.1 Flow of Process

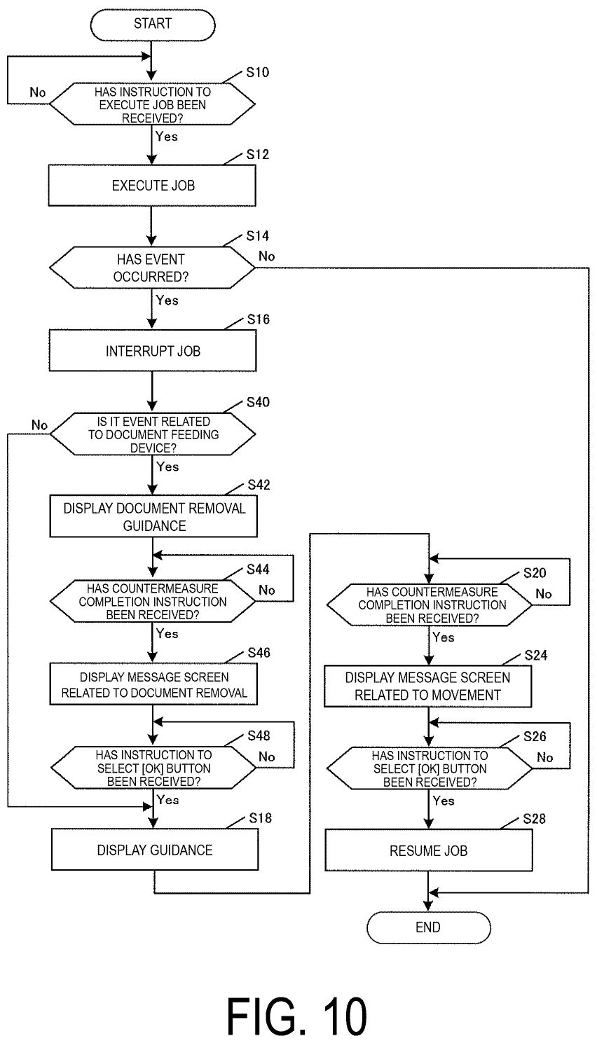

A flow of a process according to the third embodiment can be described by replacing the flowchart of FIG. 3 according to the first embodiment with a flowchart of FIG. 10. Thus, in FIG. 10, the same processes as those in FIG. 3 are denoted by the same step numbers, and the description thereof will be omitted. In FIG. 10, description is given on the assumption that an event that has occurred involves a jam related to document feeding in a document feeding device. The third embodiment is a form in which even when a plurality of events occur at the same time, it is possible to appropriately cope with each of the events.

When a job is interrupted due to the occurrence of an event, a controller 11 determines whether the event that has occurred is an event related to the document feeding device (step S14; Yes→step S16→step S40).

When the controller 11 determines that the event that has occurred is an event related to the document feeding device, the controller 11 displays guidance for coping with the event (step S40; Yes→step S42). Note that the guidance displayed by the controller 11 is guidance (document removal guidance) for removing a document that has caused a paper jam from the document feeding device. On the other hand, when it is determined that the event that has occurred is not an event related to the document feeding device, the controller 11 causes the process to proceed to step S18 (step S40; No→step S18).

When the user attempts to clear the event related to the document feeding device in accordance with the display of the document removing guidance in step S42, the controller 11 determines whether a countermeasure completion instruction such as an instruction to select an end button for receiving an instruction to end the guidance has been received (step S44).

When it is determined that the countermeasure completion instruction has been received, the controller 11 displays a message screen related to document removal (step S44; Yes→step S46).

Then, the controller 11 determines whether an instruction to select an OK button indicating that the user has confirmed the message regarding document removal has been received on the displayed message screen (step S48).

When the controller 11 determines that the instruction to select the OK button has been received, the controller 11 executes the processes of step S18 and the subsequent steps described with reference to FIG. 3 (step S48; Yes→step S18). Note that, in step S18, the controller 11 displays appropriate guidance in accordance with the event that has occurred. For example, when the event that has occurred is a printing-related event such as a jam, the controller 11 displays guidance for clearing the jam described in the first embodiment. On the other hand, when it is determined that the instruction to select the OK button has not been received, the controller 11 waits until the selection instruction is received (step S48; No).

The processes of step S18 and the subsequent steps can be performed in the same manner as the processes described with reference to FIG. 3, and thus the description thereof will be omitted here.

### 3.2 Example of Operation

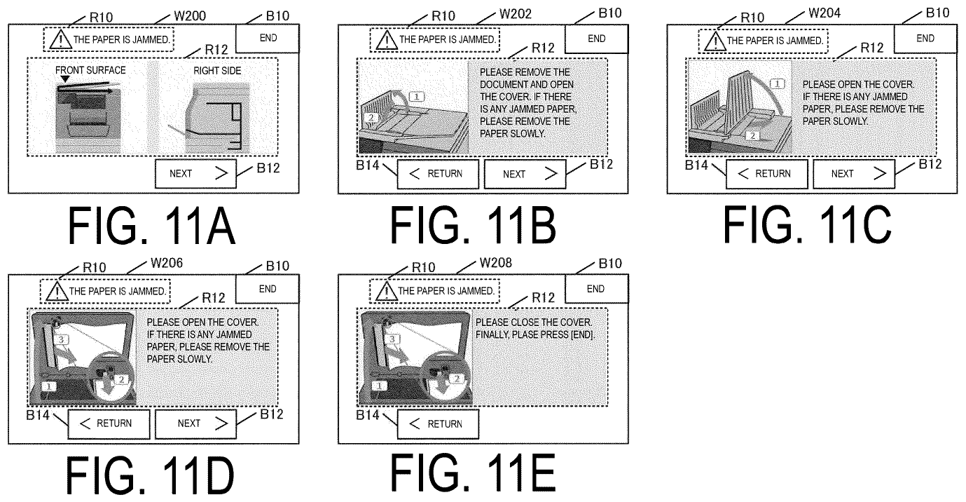

Next, an example of an operation according to the third embodiment will be described. FIGS. 11A to 11E are diagrams illustrating examples of configurations of document removal guidance screens W200 to W208 displayed by the controller 11 when a jam occurs in the document feeding device. The document removal guidance screens W200 to W208 illustrated in FIGS. 11A to 11E are examples of jam guidance provided to the user to clear a jam that has occurred, and are configured such that the jam can be cleared by an operation according to a procedure shown in the order of FIGS. 11A, 11B, 11C, 11D, and 11E. In FIGS. 11A to 11E, components common to the guidance screens W100 to W106 illustrated in FIG. 4 will be described using the same reference numerals.

FIG. 11A illustrates an example of the configuration of the document removal guidance screen W200 displayed by the controller 11 after a jam occurs, and is a so-called screen referred to as a jam map. The document removal guidance screen W200 includes an event display area R10 for displaying the content of an event that has occurred, a guidance display area R12 for displaying the content of guidance, an End button B10, and a Next button B12.

The event display area R10 illustrated in FIG. 11A is an example in which “The paper is jammed,” indicating that the event that has occurred is a jam is displayed. The guidance display area R12 schematically shows a location at which the jam has occurred. The user can visually check the location at which the jam has occurred by checking a schematic diagram displayed in the guidance display area R12.

The End button B10 is a button for receiving an instruction to end the document removal guidance from the user. When the controller 11 receives an instruction to select the End button B10, which is a countermeasure completion instruction, from the user, the controller 11 executes processes related to step S46 and the subsequent steps in FIG. 10.

The Next button B12 is a button for receiving a screen transition instruction from the user. When the controller 11 receives an instruction to select the Next button B12 from the user, the controller 11 causes the screen to transition to a document removal guidance screen W202 illustrated in FIG. 11B.

FIG. 11B illustrates an example of the configuration of a guidance screen W102 displayed by the controller 11 when receiving an instruction to select the Next button B12 on the document removal guidance screen W200. A display configuration of the document removal guidance screen W202 is obtained by adding a Back button B14 to the document removal guidance screen W200 illustrated in FIG. 11A.

In the guidance display area R12 of the document removal guidance screen W202, an operation method for removing documents from the document feeding device is displayed. FIG. 11B illustrates an example, as an operation method for removing documents, in which a message having a content of “Please remove the document and open the cover. If there is any jammed paper, please remove the paper slowly.” and an illustration including a document cover and arrows indicating an opening direction of the document cover and a removal direction of a document are displayed in the guidance display area R12.

The Back button B14 is a button for receiving a screen transition instruction from the user. When the controller 11 receives an instruction to select the Back button B14 from the user, the controller 11 causes the screen to transition to the document removal guidance screen W200 illustrated in FIG. 11A.

FIG. 11C illustrates an example of the configuration of a document removal guidance screen W204 displayed by the controller 11 when receiving an instruction to select the Next button B12 on the document removal guidance screen W202. A display configuration of the document removal guidance screen W204 is the same as that of the document removal guidance screen W202 illustrated in FIG. 11B.

In the guidance display area R12 of the document removal guidance screen W204, an operation method for removing documents is displayed following the operation method displayed in the guidance display area R12 of the document removal guidance screen W202. FIG. 11C illustrates an example, as an operation method for removing documents, in which a message having a content of “Please open the cover. If there is any jammed paper, please remove the paper slowly.” and an illustration including a document cover and arrows indicating an opening direction of the document cover and a removal direction of a document are displayed in the guidance display area R12.

FIG. 11D illustrates an example of the configuration of a document removal guidance screen W206 displayed by the controller 11 when receiving an instruction to select the Next button B12 on the document removal guidance screen W204. A display configuration of the document removal guidance screen W206 is the same as that of the document removal guidance screen W202 illustrated in FIG. 11B.

In the guidance display area R12 of the document removal guidance screen W206, an operation method for removing documents is displayed following the operation method displayed in the guidance display area R12 of the document removal guidance screen W204. FIG. 11D illustrates an example, as an operation method for removing documents, in which a message having a content of “Please open the cover. If there is any jammed paper, please remove the paper slowly.” and an illustration including a document cover and arrows indicating an opening direction of the document cover and a removal direction of a document are displayed in the guidance display area R12.

FIG. 11E illustrates an example of the configuration of a document removal guidance screen W208 displayed by the controller 11 when receiving an instruction to select the Next button B12 on the document removal guidance screen W206. Since the document removal guidance screen W208 is a final screen of document removal guidance related to clearing of a jam, the Next button B12 illustrated in the document removal guidance screens W200 to W206 is not provided.

In the guidance display area R12 of the document removal guidance screen W208, a method of operating the cover after removing a jammed document is displayed. FIG. 11E illustrates an example in which a message having a content of “Please close the cover. Finally, please press [End].” and an illustration including a document cover and an arrow indicating a closing direction of the document cover are displayed in the guidance display area R12.

In the third embodiment, when the user confirms the message content of “Please close the cover. Finally, press [End]” displayed in the guidance display area R12 and an instruction to select the End button B10 on the document removal guidance screen W208 as a countermeasure completion instruction is received, the controller 11 displays a message screen related to document removal, which will be described in the next drawing.

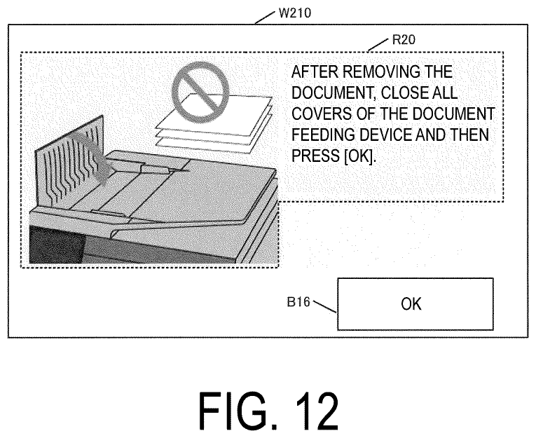

FIG. 12 illustrates an example of the configuration of a message screen W210 that displays a message regarding document removal displayed by the controller 11 when receiving an instruction to select the End button B10 on the document removal guidance screen W208 in FIG. 11E. Note that the user can select the End button B10 on the guidance screens W200 to W206 in FIGS. 11A to 11D, and when the End button B10 is selected on any of the guidance screens W200 to W206 and the paper jam has been cleared at that point in time, the controller 11 ends the jam guidance and displays the message screen W108.

The message screen W210 includes a message display area R20 that displays, as an example of a message regarding document removal, “After removing the document, close all covers of the document feeding device and then press [OK]”, and an OK button B16 for receiving a selection instruction when the user has confirmed the message displayed in the message display area R20.

When an instruction to select the OK button B16 is received from the user, the controller 11 confirms the open/close state of the cover and a document removal state. For example, when the cover is closed but the document is not removed at the time of receiving the instruction to select the OK button B16, the controller 11 determines that the document is retained, and issues a warning (for example, emission of a warning sound such as a beep, display of a warning screen such as a warning message, or the like) to the user. Further, for example, when the cover is opened, a document feed roller cannot be driven and a document stopper for regulating a document feed position cannot be disposed at a predetermined regulation position, and thus, also in this case, the controller 11 may issue a warning to the user.

On the other hand, when the cover is closed and the document is removed, the controller 11 determines that the jam in the document feeding device has been cleared, and proceeds with processes related to step S18 and the subsequent steps in FIG. 10. In the third embodiment, the processes related to step S18 and the subsequent steps in FIG. 10 can be the same as the processes described in the flowchart of FIG. 3 or FIG. 6.

Here, in the third embodiment, a mode in which the only event that has occurred is a jam in the document feeding device will be supplementarily described.

When the only event that has occurred is a jam in the document feeding device, the controller 11 displays a predetermined message screen when the user selects the OK button B16 on the message screen W210 in step S48 of FIG. 10, and causes the screen to transition to a job executing screen before the occurrence of the jam.

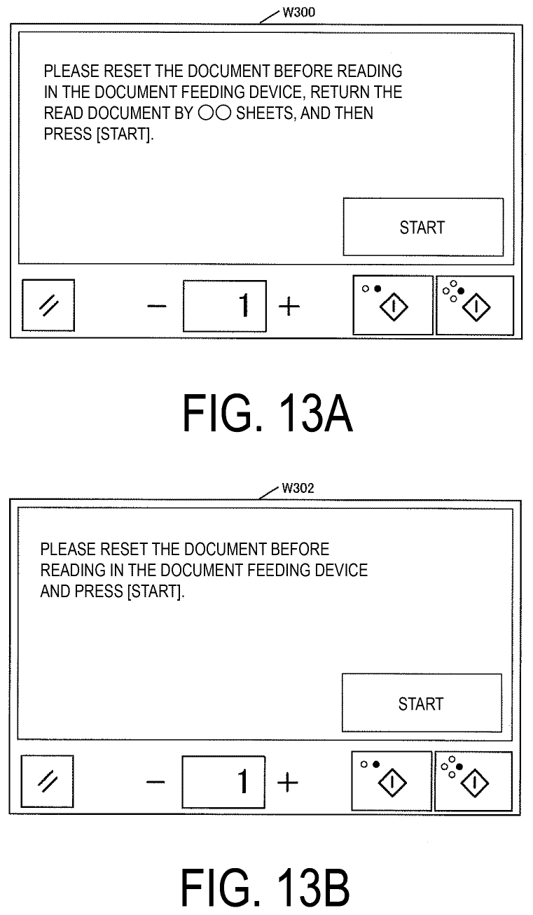

For example, FIG. 13A illustrates an example of the configuration of a predetermined message screen displayed by the controller 11 when a document returning operation is required due to the occurrence of an event (a jam in the document feeding device) during the execution of a copy job.

A predetermined message screen W300 in FIG. 13A is an example of a predetermined message screen having a message content of “Please reset the document before reading in the document feeding device, return the read document by [symbol] [symbol] sheets, and then press [start]”.

On the other hand, FIG. 13B illustrates an example of the configuration of a predetermined message screen displayed by the controller 11 when a document returning operation is not required but the reading of all documents has not been completed due to the occurrence of an event (a jam in the document feeding device) during the execution of a copy job.

A predetermined message screen W302 in FIG. 13B is an example of a predetermined message screen having a message content of “Please reset the document before reading in the document feeding device and press [start]”.

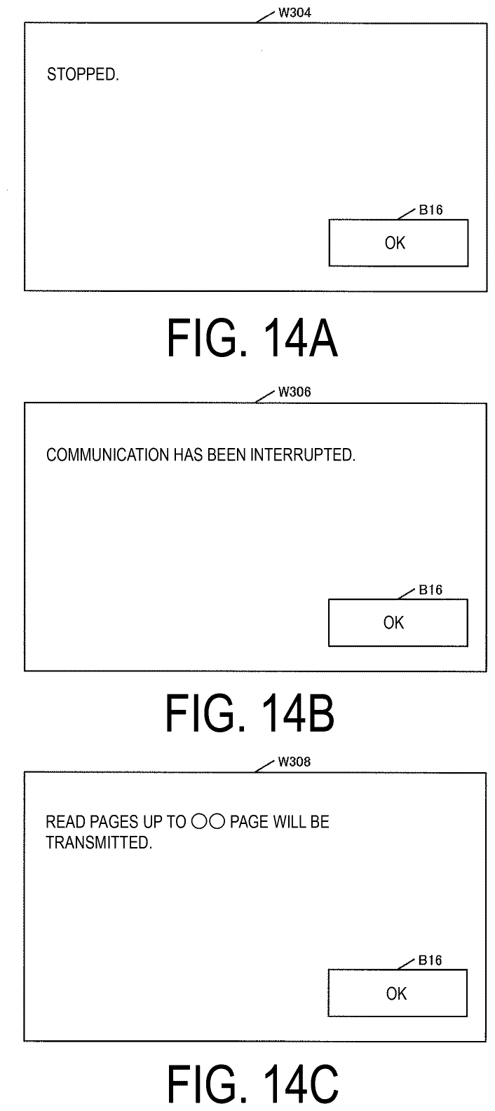

In addition, FIG. 14A illustrates an example of the configuration of a predetermined message screen W304 displayed by the controller 11 when a job being executed is a scan job.

The predetermined message screen W304 in FIG. 14A is an example of a predetermined message screen having a message content of “Stopped” indicating that the reading of the document has been stopped.

In addition, FIG. 14B illustrates an example of the configuration of a predetermined message screen W306 displayed by the controller 11 when a job being executed is a fax job (direct transmission).

A predetermined message screen W306 in FIG. 14B is an example of a predetermined message screen having a message content of “Communication has been interrupted” indicating that fax transmission based on the read document has been stopped.

FIG. 14C illustrates an example of the configuration of a predetermined message screen W308 displayed by the controller 11 when a job being executed is a fax job (when the job is memory transmission or time-specified transmission and the reading of a document has been completed at the time of partial transmission).

The predetermined message screen W308 in FIG. 14C is an example of a predetermined message screen having a message content of “Read pages up to [symbol] [symbol] page will be transmitted” indicating that the reading of some documents has been completed, but a document to be read next is retained, and fax transmission is performed on the basis of the read document.

As described above, according to the third embodiment, when an event that has occurred involves a jam that has occurred in the document feeding device, a message regarding the movement of the housing 25 is displayed after coping with the jam that has occurred in the document feeding device, and thus it is possible to correctly resume the job without hindering the display of work guidance related to the document feeding device.

### 4 Fourth Embodiment

A fourth embodiment is a from in which, in the firsts to third embodiments and the like, when opening or closing of the cover 27 on the rear side of the multifunction apparatus 100 is involved to clear an event that has occurred, an operation button for receiving a rotation instruction to rotate a display content of the display 13 (operation inputter 15) toward the user and display the display content, or code information indicating the content of guidance is displayed on the display 13 (operation inputter 15).

### 4.1 Operation Example

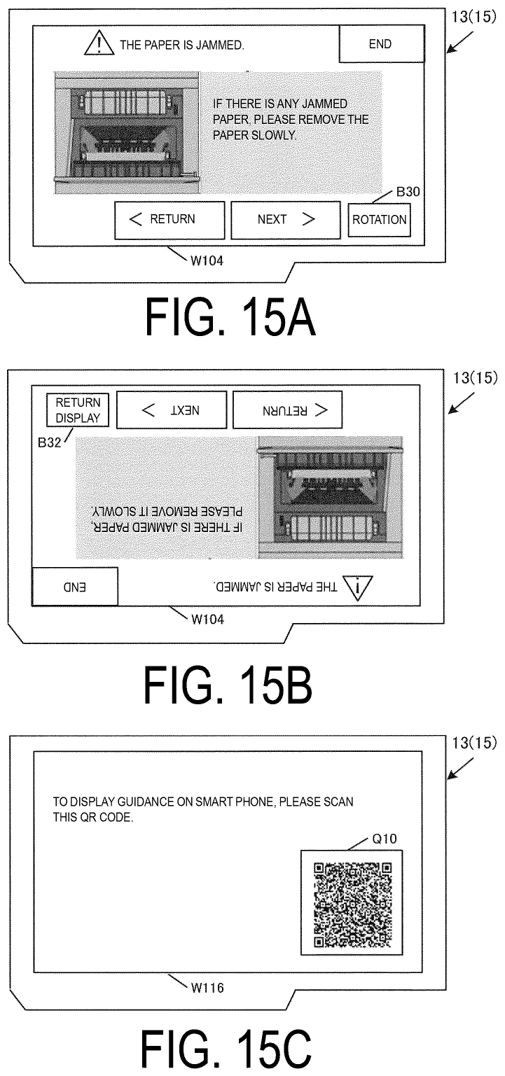

FIG. 15A illustrates an example of the configuration of the guidance screen W104 including a rotation button B30 for receiving a rotation instruction to rotate a guidance content displayed on the display 13 (operation inputter 15) toward the user and display the guidance content.

For example, when or after the user moves to the rear side of the multifunction apparatus 100 to clear a jam that has occurred, the user can rotate and display the display content of the guidance screen W104 by selecting the rotation button B30. FIG. 15B shows a state in which the guidance screen W104 is rotated 180 degrees by the user selecting the rotation button B30. An example of FIG. 15B is an example in which the display content of the guidance screen W104 is rotated 180 degrees by one selection of the rotation button B30, but, for example, the display content of the guidance screen W104 may be rotated to a predetermined rotation angle such as 90 degrees, 180 degrees, 270 degrees, or 360 degrees from a display position (front position) illustrated in FIG. 15A each time the rotation button B30 is selected (pressed). The display content rotated by the selection of the rotation button B30 can be returned to an original display position by the selection of a return display button B32. Further, the return display button B32 may be displayed instead of the rotation button B30 when the guidance screen W104 is rotated by selecting the rotation button B30. Further, the embodiment in which the display content of the guidance screen W104 can be rotated by selecting the rotation button B30 provided on the guidance screen W104 and displayed has been described with reference to FIGS. 15A and 15B, the embodiment may be, for example, an embodiment in which a mechanical rotation mechanism (not shown) is provided on the display 13 (operation inputter 15), and the display 13 (operation inputter 15) itself is physically rotated so that the display content of the guidance can be rotated.

On the other hand, FIG. 15C illustrates an example of the configuration of a code screen W116 for displaying code information indicating the content of the guidance. Note that the code screen W116 can be called up, for example, by selecting a call button provided on a jam guidance screen, and the call button may be displayed only when a jam that is cleared by access from the rear side of the multifunction apparatus 100 (housing 25) has occurred. For example, when the user attempts to clear the jam while looking at an operation screen of a mobile terminal such as a smartphone carried by the user, the user can acquire the display content of the guidance screen by reading code information Q10 displayed on the code screen W116. In this case, the code information may be a one-dimensional code such as a barcode (for example, EAN code, JAN code, Codbar, or CODE128) or may be a two-dimensional code. The two-dimensional code may be a stack-type two-dimensional code (for example, PDF417 or CODE49) or may be a matrix-type two-dimensional code (for example, Quick Response Code (QR Code (registered trademark)), Data Matrix, VeriCode, or Aztec).

The code information Q10 has embedded address information for accessing a server (not shown; which may be the multifunction apparatus 100 itself) that manages information on the guidance screen. The user can read the address information embedded in the code information using a code information reading function of the smartphone and acquire information on the guidance screen from the server specified by the address information.

Even when the user is located on (moved to) the rear side of the multifunction apparatus 100 (housing 25), the user can clear the jam while referring to the guidance screen displayed on the operation screen of the smartphone, which greatly improves operability when the jam is cleared.

As described above, according to the fourth embodiment, even when the housing 25 is moved to open or close the cover 7 or the like on the rear side of a multifunction apparatus 1000 in order to clear an event that has occurred, the user can perform an operation while confirming the guidance screen displayed directly in front of the user, and thus it is possible to more efficiently clear the event that has occurred.

The disclosure is not limited to the above-described embodiments, and various modifications can be made. In other words, the technical scope of the disclosure also includes embodiments obtained by combining technical means that are appropriately modified within the scope of the gist of the disclosure.

Further, although the above-described embodiments are described separately for convenience of description, it is obvious that the embodiments may be executed in combination within a technically possible scope.

Further, in the embodiments, a program operating on each apparatus is a program that controls a CPU or the like (a program for causing a computer to function) to realize the functions of the above-described embodiments. Information handled by such an apparatus is temporarily stored in a temporary storage device (for example, a RAM) during the process and then stored in various storage devices such as read only memories (ROMs) and HDDs, and is read, modified, and written by the CPU as necessary.

Here, a computer-readable non-transitory recording medium on which a program is recorded in an information processing apparatus may be any of a semiconductor medium (for example, a ROM or a non-volatile memory card), an optical recording medium/magnetic optical recording medium (for example, a digital versatile disc (DVD), magneto optical disc (MO), mini disc (MD), compact disc (CD), or Blu-ray (BD; registered trademark) disc)), a magnetic recording medium (for example, a magnetic tape or flexible disk), and the like. In this case, the program recorded on the recording medium is read by the computer of the information processing apparatus and executed by the computer, such that not only the functions of the above-described embodiment are realized, but also functions of the disclosure are realized by performing processing in cooperation with an operating system, another application program, or the like based on instructions of the program.

Further, when a program is distributed in a market, the program can be stored in a portable recording medium and distributed, or can be transferred to a server computer connected via a network such as the Internet. In this case, it is obvious that a storage device of the server computer is also included in the disclosure.

Further, each functional block or feature of the apparatus used in the above-described embodiment can also be implemented and executed by an electric circuit, such as an integrated circuit or a plurality of integrated circuits. The electric circuit designed to realize the functions described herein may include a general-purpose processor, a digital signal processor (DSP), an application-specific integrated circuit (ASIC), a field programmable gate array (FPGA), another programmable logic device, a discrete gate or transistor logic, a discrete hardware component, or a combination thereof. The general-purpose processor may be a microprocessor, or any known processor, controller, microcontroller, or state machine. The electric circuit described above may be configured of a digital circuit or may be configured of an analog circuit. Further, when an integrated circuit technology for replacement into a current integrated circuit emerges with the development of semiconductor technology, a new integrated circuit based on the technology may also be used in one or more aspects of the disclosure.

### REFERENCE SIGNS LIST

11 Controller
13 Display
15 Operation inputter
17 Communicator
19 Image former
21 Image inputter
23 Storage
25 Housing
27, 29 Cover
31 Feed tray
100 Multifunction apparatus

1. An image forming apparatus comprising:
one or more controllers that control execution of a job; and
a display that displays a message regarding movement of a housing under control of the one or more controllers,
wherein the one or more controllers control a display mode of the message regarding the movement of the housing, based on a predetermined condition when an event occurs and a countermeasure involving the movement of the housing is performed as a countermeasure for the event that has occurred.

2. The image forming apparatus according to claim 1, wherein, when it is determined that the countermeasure for the event that has occurred corresponds to specific work by a user as the predetermined condition, the one or more controllers restrict display of the message regarding the movement of the housing.

3. The image forming apparatus according to claim 2, wherein the specific work includes adjustment work during production of the image forming apparatus or maintenance work by a maintenance user.

4. The image forming apparatus according to claim 1, wherein the one or more controllers control a display content of the message regarding the movement of the housing in accordance with whether there is a job to be executed after the countermeasure for the event that has occurred has been performed as the predetermined condition.

5. The image forming apparatus according to claim 4, wherein, when there is a job to be executed after the countermeasure for the event that has occurred has been performed, the one or more controllers display, on the display, a selection button for receiving a screen transition instruction to transition to a screen for receiving an execution stop instruction to stop the job together with the message regarding the movement of the housing.

6. The image forming apparatus according to claim 1, further comprising a document feeding device,
wherein the one or more controllers display a message regarding document removal before displaying the message regarding the movement of the housing when the event that has occurred involves a jam occurring in the document feeding device as the predetermined condition.

7. The image forming apparatus according to claim 6, wherein the one or more controllers display, on the display, a selection button for receiving an execution stop instruction to stop the job together with the message regarding the movement of the housing after displaying the message regarding document removal.

8. The image forming apparatus according to claim 1, wherein the one or more controllers display, on the display, an operation button for receiving an instruction to rotate a display content on the display or code information indicating a content of guidance.

9. A control method for an image forming apparatus, the control method comprising:
controlling execution of a job;
displaying a message regarding movement of a housing under control of one or more controllers; and
controlling a display mode of the message regarding the movement of the housing, based on a predetermined condition when an event occurs and a countermeasure involving the movement of the housing is performed as a countermeasure for the event that has occurred.
